(19) United States
(12) Patent Application Publication
(10) Pub. No.: US 2026/0022930 A1
(43) Pub. Date: Jan. 22, 2026

(54) THIN FILM INSPECTION DEVICE AND METHOD

(71) Applicant: Samsung Display Co., LTD., Yongin-si (KR)

(72) Inventors: Ohjune Kwon, Yongin-si (KR); Junghan Seo, Yongin-si (KR)

(21) Appl. No.: 19/095,409

(22) Filed: Mar. 31, 2025

(30) Foreign Application Priority Data
Jul. 16, 2024 (KR) 10-2024-0094004

(51) Int. Cl. G01B 11/06

(52) U.S. Cl. CPC G01B 11/06

(57) ABSTRACT

A device for inspecting a thin film with a varying refractive index includes a light source emitting first light toward the thin film on a first surface of the thin film, the first light being incident at a first angle with reference to the first surface on the first surface and a light-receiving portion detecting second light emitted from a second surface of the thin film, the second light being emitted at a second angle with reference to the second surface, where the first surface is one of an upper surface and a lower surface of the thin film, and the second surface is a remaining (the other) one of the upper surface and the lower surface of the thin film.

This application claims priority to Korean Patent Application No. 10-2024-0094004, filed on Jul. 16, 2024, and all the benefits accruing therefrom under 35 U.S.C. § 119, the content of which in its entirety is herein incorporated by reference.

### BACKGROUND

### 1. Field

Embodiments relate to a device and method for inspecting a thin film. A thin film subject to inspection in embodiments may be a thin film included in an electronic device, e.g., a display device.

### 2. Description of the Related Art

Display devices visually display data. The display devices may provide images by light-emitting diodes. The uses of display devices are diversified, and a variety of designs to improve the quality of a display device is attempted.

A display device may have a structure in which a plurality of thin films including light-emitting diodes is stacked. Some of the thin films may transmit light. Some of the thin films may have a generally constant refractive index in the thickness direction thereof. Some of the thin films may have a refractive index that varies in the thickness direction thereof. For example, some of the thin films may have a refractive index that gradually varies in the thickness direction thereof.

### SUMMARY

A thin film may be inspected to identify the characteristics of the thin film, and the inspection may include measuring a thickness of the thin film. Generally, for a thin film with a constant refractive index, light is incident on the thin film at a constant incident angle and emitted light (reflected light or transmitted light) is detected, and then, the thickness of the thin film may be predicted using a detected position of the light.

However, for a thin film with a refractive index that gradually varies, light may be refracted multiple times within the thin film, and accordingly, it may be difficult to predict a position where emitted light (reflected light or transmitted light) is emitted, an emission angle (i.e., an angle defined by emitted light with an emission surface), and characteristics (e.g., thickness) of the thin film according thereto.

Additional features will be set forth in part in the description which follows and, in part, will be apparent from the description, or may be learned by practice of the presented embodiments of the disclosure.

In an embodiment of the disclosure, a device for inspecting a thin film with a varying refractive index includes a light source emitting first light toward a first surface of the thin film, the first light being incident at a first angle with reference to the first surface on the first surface and a light-receiving portion detecting second light emitted from a second surface of the thin film, the second light being emitted at a second angle with reference to the second surface, where the first surface is one of an upper surface and a lower surface of the thin film, and the second surface is a remaining (the other) one of the upper surface and the lower surface of the thin film.

In an embodiment, the light source and the light-receiving portion may be disposed on opposite sides with respect to the thin film.

In an embodiment, the thin film may have a refractive index that gradually varies in a predetermined direction, and the first angle and the second angle may be different from each other.

In an embodiment, the light-receiving portion may include a first scale pattern indicating a position where the second light is detected.

In an embodiment, the thin film inspection device may further include a substrate including a second scale pattern corresponding to the first scale pattern, where the thin film is disposed on the substrate.

In an embodiment, the second scale pattern may be partially overlapped with the thin film and extending outside an area where the thin film is disposed.

In an embodiment, the substrate may include a transmission portion, and the thin film may be at least partially overlapped with the transmission portion.

In an embodiment, the first light may include white light.

In an embodiment, the light source may include a surface light source, and an area of the first light and an area of the second light may be different from each other.

In an embodiment of the disclosure, a method of inspecting a thin film with a varying refractive index includes emitting, by a light source, first light toward a first surface of the thin film, the first light being incident at a first angle with reference to the first surface on the first surface, and detecting, by a light-receiving portion, second light emitted from a second surface of the thin film, the second light being emitted at a second angle with reference to the second surface, where the first surface is one of an upper surface and a lower surface of the thin film, and the second surface is a remaining (the other) one of the upper surface and the lower surface of the thin film thin film.

In an embodiment, the light source and the light-receiving portion may be arranged on opposite sides with respect to the thin film.

In an embodiment, the first angle and the second angle may be different from each other.

In an embodiment, the light-receiving portion may include a first scale pattern indicating a position where the second light is detected, and the method may further include deriving a position where the second light is detected.

In an embodiment, the thin film inspection method may further include deriving a position where third light that is emitted light of the first light is detected when a refractive index of the thin film is constant.

In an embodiment, the thin film inspection method may further include determining the second angle by comparing a detected position of the second light and a detected position of the third light.

In an embodiment, the thin film inspection method may further include arranging the thin film on a substrate including a second scale pattern corresponding to the first scale pattern.

In an embodiment, the substrate may include a transmission portion, and the thin film is at least partially overlapped with the transmission portion.

In an embodiment, the second scale pattern may be partially overlapped with the thin film and extending outside an area where the thin film is disposed.

In an embodiment, the first light may include white light, chromatic aberration may occur in the second light that has passed through the thin film so that a detected position varies for each wavelength of the second light, and the method further include measuring a deviation between different detected positions for each wavelength of the second light.

In an embodiment, the light source may include a surface light source, an area of the first light and an area of the second light may be different from each other, and the method may further include comparing the area of the first light and the area of the second light.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a schematic cross-sectional view of an embodiment of a thin film inspection device;

FIG. 2 is a schematic cross-sectional view of an embodiment of a thin film inspection device;

FIG. 3 is a schematic cross-sectional view of an embodiment of a thin film inspection device.

FIGS. 4A, 4B, 4C, and 4D are schematic plan views showing embodiments of portions of substrates in some embodiments;

FIG. 5 is a schematic cross-sectional view of an embodiment of a thin film inspection device;

FIG. 6 is a schematic cross-sectional view of an embodiment of a thin film inspection device;

FIGS. 7A and 7B are schematic cross-sectional views showing an embodiment of operations of a thin film inspection method;

FIGS. 8A and 8B are schematic cross-sectional views showing another embodiment of operations of a thin film inspection method;

FIG. 9 is a schematic graph showing an embodiment of an operation of a thin film inspection method in an embodiment represented in an orthogonal coordinate system;

FIG. 10 is a schematic cross-sectional view showing an embodiment of an operation of a thin film inspection method; and

FIG. 11 is a schematic cross-sectional view showing an embodiment of an operation of a thin film inspection method.

### DETAILED DESCRIPTION

Reference will now be made in detail to embodiments, embodiments of which are illustrated in the accompanying drawings, where like reference numerals refer to like elements throughout. In this regard, the illustrated embodiments may have different forms and should not be construed as being limited to the descriptions set forth herein. Accordingly, the embodiments are merely described below, by referring to the drawing figures, to explain features of the description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Various modifications may be applied to the illustrated embodiments, and particular embodiments will be illustrated in the drawings and described in the detailed description section. The effect and features of the illustrated embodiments, and a method to achieve the same, will be clearer referring to the detailed descriptions below with the drawings. However, the illustrated embodiments may be implemented in various forms, not by being limited to the embodiments presented below.

Hereinafter, embodiments will be described in detail with reference to the accompanying drawings, and in the description presented with reference to the drawings, the same or corresponding constituents are indicated by the same reference numerals and redundant descriptions thereof are omitted.

In the following embodiment, it will be understood that although the terms “first”, “second”, etc. may be used herein to describe various elements, these elements should not be limited by these terms. These elements are only used to distinguish one element from another.

In the following embodiment, as used herein, the singular forms “a,” “an,” and “the” are intended to include the plural forms as well, unless the context clearly indicates otherwise.

In the following embodiment, it will be further understood that the terms “comprises” and/or “comprising” used herein specify the presence of stated features or elements, but do not preclude the presence or addition of one or more other features or components.

In the following embodiment, when a portion such as a film, a region, and a component is also referred to as being above or on other portions, this includes the case in which the portion is directly on other portions as well as the case in which other films, other regions, and components are disposed therebetween.

Sizes of elements in the drawings may be exaggerated for convenience of explanation. For example, sizes and thicknesses of the elements shown in the drawings are for the purpose of descriptive convenience, and thus the disclosure is not necessarily limited thereto.

When an illustrative embodiment may be implemented differently, a predetermined process order may be performed differently from the described order. For example, two consecutively described processes may be performed substantially at the same time or performed in an order opposite to the described order.

In the disclosure, the expression such as “A and/or B” may include A, B, or A and B. The expression such as “at least one of A and B” may include A, B, or A and B.

In the following embodiment, it will be understood that when a layer, region, or element is also referred to as being “connected to” another layer, region, or element, it may be directly connected to the other layer, region, or component or indirectly connected to the other layer, region, or component via intervening layers, regions, or components. For example, in the disclosure, when a layer, region, or component is also referred to as being electrically connected to another layer, region, or component, it may be directly electrically connected to the other layer, region, or component or indirectly electrically connected to the other layer, region, or component via intervening layers, regions, or components.

The x-axis, y-axis, and z-axis are not limited to the three axes of the orthogonal coordinate system, and may be interpreted in a broad sense including them. In an embodiment, the x-axis, y-axis, and z-axis may be orthogonal to each other, for example, but may refer to different directions that are not orthogonal to each other.

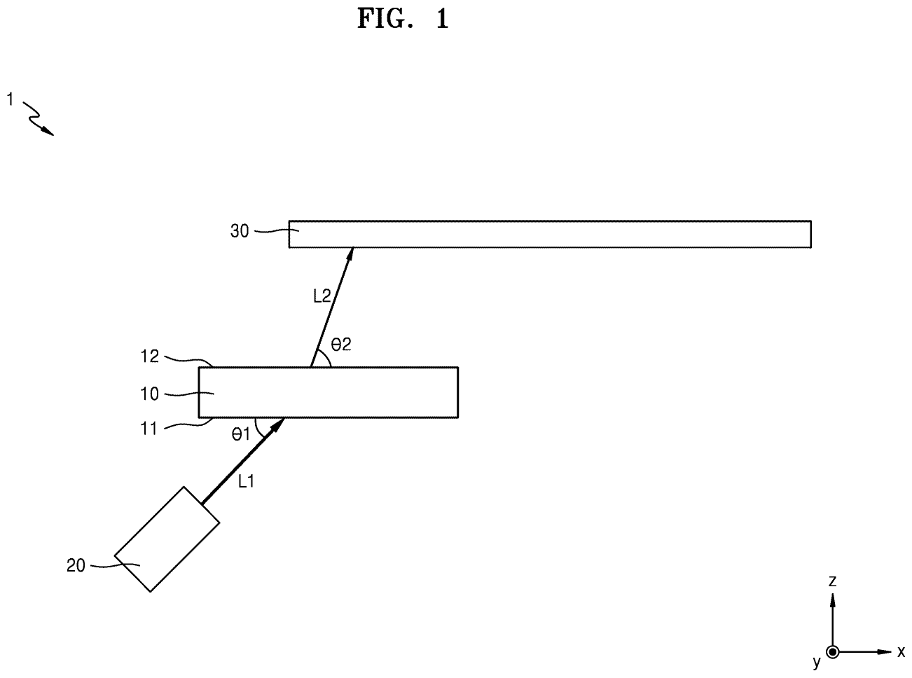

FIG. 1 is a schematic cross-sectional view of an embodiment of a thin film inspection device 1.

Referring to FIG. 1, the thin film inspection device 1 in an embodiment may include a light source 20 and a light-receiving portion 30. A thin film 10 may be an inspection target of the thin film inspection device 1 in an embodiment. The thin film 10 may include a first surface 11 and a second surface 12. In an embodiment, each of the first surface 11 and the second surface 12 may be defined by a first direction x and a second direction y.

In an embodiment, the first surface 11 and the second surface 12 of the thin film 10 may be opposite surfaces to each other. In an embodiment, the second surface 12 of the thin film 10 may be a surface facing a third direction (e.g., an upper direction) z, and the first surface 11 may be a surface facing a direction (e.g., a lower direction) opposite to the third direction z, for example. In other words, the first surface 11 of the thin film 10 may be a lower surface of the thin film 10, and the second surface 12 of the thin film 10 may be an upper surface of the thin film 10. In the disclosure, a case in which the first surface 11 is a lower surface and the second surface 12 is an upper surface is illustrated and mainly described below, but the disclosure is not limited thereto. In another embodiment, the first surface 11 is an upper surface, and the second surface 12 is a lower surface.

In an embodiment, the thin film 10 may be disposed between the light source 20 and the light-receiving portion 30. In other words, the light source 20 and the light-receiving portion 30 may be disposed at opposite sides with respect to the thin film 10. In an embodiment, the thin film 10 may be disposed in the third direction z with respect to the light source 20, and the light-receiving portion 30 may be disposed in the third direction z with respect to the thin film 10, for example.

In an embodiment, the light source 20 may emit first light L1 toward the first surface 11 of the thin film 10. In other words, the first light L1 may be light incident on the first surface 11 of the thin film 10. In an embodiment, the first light L1 may be incident light on the first surface 11 of the thin film 10 at a first angle θ1.

In an embodiment, second light L2 may be emitted from the second surface 12 of the thin film 10. In other words, the second light L2 may be emitted light from the second surface 12 of the thin film 10. In an embodiment, the second light L2 may be emitted from the second surface 12 of the thin film 10 at a second angle θ2.

In an embodiment, the thin film 10 may transmit light. In an embodiment, the first light L1 may pass through the thin film 10 to travel to the outside of the thin film 10. In an embodiment, the second light L2 may be light after the first light L1 passes through the thin film 10, for example. In an embodiment, the light source 20 may be a point light source, and the first light L1 and the second light L2 may be point light of a single wavelength.

In an embodiment, the thin film 10 may be a film with a refractive index that gradually varies. In other words, the thin film 10 may have a refractive index gradient. In an embodiment, the thin film 10 may have a refractive index that gradually varies in the thickness direction (e.g., the third direction z). The first light L1 incident on the thin film 10 may be refracted multiple times within the thin film 10. Accordingly, the first angle θ1 that is an incident angle of the first light L1 and the second angle θ2 that is an emission angle of the second light L2 may be different from each other.

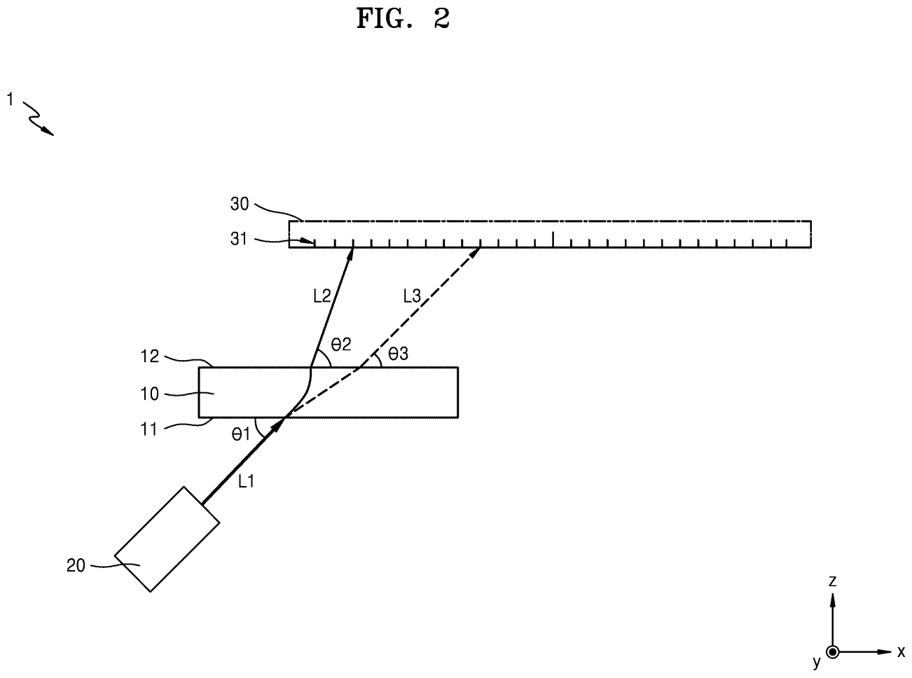

FIG. 2 is a schematic cross-sectional view of an embodiment of the thin film inspection device 1.

Referring to FIG. 2, the first light L1 may be emitted after being refracted multiple times within the thin film 10, and the emitted light is represented as the second light L2. A path in which the first light L1 refracts multiple times within the thin film 10 is illustrated by a curved solid line in the thin film 10.

When the thin film 10 has a constant refractive index in the thickness direction (e.g., the third direction z), the first light L1 may be emitted after being refracted once within the thin film 10, and the emitted light is represented as third light L3. A path in which the first light L1 refracts once within the thin film 10 is illustrated by a dashed line in the thin film 10. A path (dashed line) of light when the refractive index of the thin film 10 is constant is a virtual path for comparison. In other words, the thin film 10 that is subject to inspection by the thin film inspection device 1 in an embodiment may be a thin film with a refractive index that varies in a predetermined direction (e.g., a thickness direction).

In an embodiment, an angle at which the first light L1 emitted from the light source 20 is incident on the thin film 10 may be defined as the first angle θ1. In an embodiment, the first angle θ1 may be an angle defined by the first light L1 with the first surface 11 of the thin film 10. In an embodiment, the first angle θ1 may be 90° or less. In an embodiment, the first angle θ1 may be adjusted by one who uses the thin film inspection device 1 (hereinafter, also referred to as the user).

In an embodiment, an angle at which the second light L2 is emitted from the thin film 10 may be defined as the second angle θ2. In an embodiment, the second angle θ2 may be an angle defined by the second light L2 with the second surface 12 of the thin film 10. In an embodiment, the second angle θ2 may be different from the first angle θ1. In an embodiment, the second angle θ2 may be 90° or less. In an embodiment, the second angle θ2 may vary according to the first angle θ1.

In an embodiment, the angle at which the third light L3 is emitted from the thin film 10 may be defined as a third angle θ3. In an embodiment, the third angle θ3 may be an angle defined by the third light L3 with the second surface 12 of the thin film 10. In an embodiment, the third angle θ3 may be the same as the first angle θ1. In an embodiment, the third angle θ3 may be 90° or less. In an embodiment, the third angle θ3 may vary according to the first angle θ1.

The light-receiving portion 30 may include a first scale pattern 31. In an embodiment, the first scale pattern 31 may be formed on a surface of the light-receiving portion 30, e.g., a surface facing the thin film 10. In an embodiment, the first scale pattern 31 may indicate the position of light incident on the light-receiving portion 30. In other words, the first scale pattern 31 may indicate the position of light detected by the light-receiving portion 30. In an embodiment, the first scale pattern 31 may indicate the position of the second light L2 or the third light L3 incident (or detected) on the light-receiving portion 30. In an embodiment, the first scale pattern 31 may be in the form of marks.

As the thin film inspection device 1 represents the position where light is detected on the light-receiving portion 30, it may help to identify characteristics of a thin film. In an embodiment, the user of the thin film inspection device I may predict the characteristics of gradient of the refractive index of the thin film 10 by comparing the detected position of the second light L2 emitted from the thin film 10 with a varying refractive index, with the detected position of the third light L3 that is emitted light when the thin film 10 is a film with a constant refractive index, for example. In this case, the first scale pattern 31 of the light-receiving portion 30 of the thin film inspection device 1 helps the user to identify the positions of the second light L2 and the third light L3. The user may predict the characteristics, such as a thickness, of the thin film 10. A method of deriving the position of the third light L3 that is virtual light on the light-receiving portion 30 is described below.

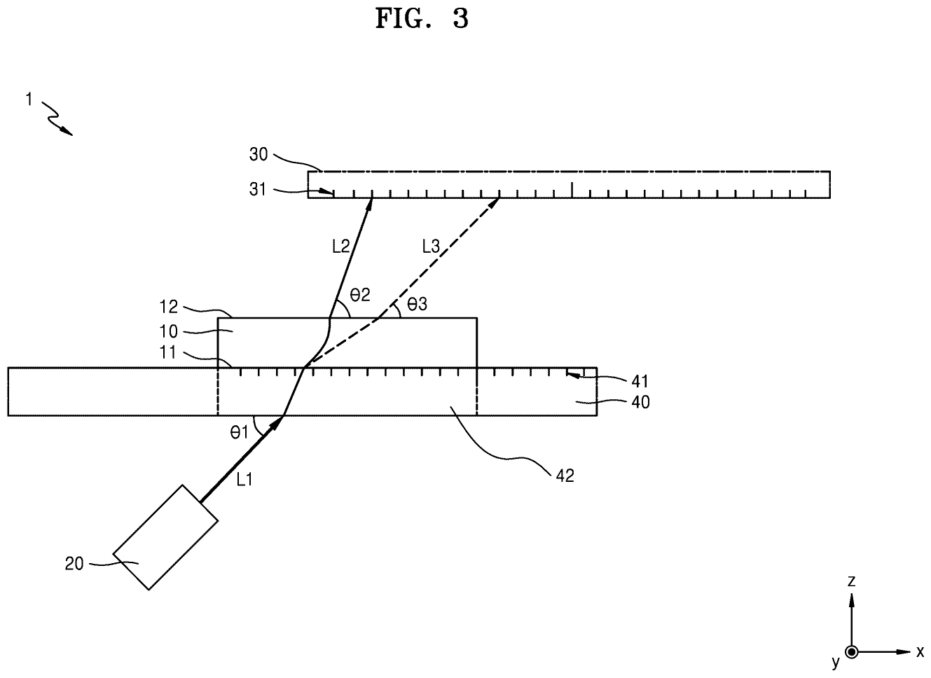

FIG. 3 is a schematic cross-sectional view of an embodiment of the thin film inspection device 1.

Referring to FIG. 3, the thin film inspection device 1 in an embodiment may further include a substrate 40.

In an embodiment, the thin film 10 may be disposed on the substrate 40. In an embodiment, the thin film 10 may be disposed in the third direction z with respect to the substrate 40, for example. The first surface 11 of the thin film 10 may be in direct contact with the substrate 40. The thin film 10 may be disposed between the substrate 40 and the light-receiving portion 30. The first light L1 may be incident on the thin film 10 by passing through the substrate 40. In an embodiment, the refractive index of the substrate 40 may be constant. Accordingly, the path of light in the substrate 40 is illustrated by a straight line.

In an embodiment, the substrate 40 may include a second scale pattern 41 for indicating the incidence position of the first light L1. In an embodiment, the second scale pattern 41 may be formed on an upper surface of the substrate 40. In an embodiment, the second scale pattern 41 may be formed on a surface of the substrate 40 facing the thin film 10, for example. In another embodiment, the second scale pattern 41 may be formed on a surface of the substrate 40 facing the light source 20. In an embodiment, the second scale pattern 41 may be in the form of marks. In an embodiment, the second scale pattern 41 may correspond to the first scale pattern 31. In an embodiment, a predetermined dimension (e.g., a distance) in the second scale pattern 41 may correspond to a predetermined dimension (e.g., a distance) in the first scale pattern 31, for example. In an embodiment, the dimension of the second scale pattern 41 may be a predetermined ratio of the dimension of the first scale pattern 31. In an embodiment, the second scale pattern 41 may have the same shape as that of the first scale pattern 31. In an embodiment, the second scale pattern 41 may overlap the thin film 10. In other words, the thin film 10 may be disposed on the substrate 40 to overlap the second scale pattern 41. In an embodiment, a portion of the second scale pattern 41 may extend over an edge of the thin film 10. In other words, the second scale pattern 41 may extend outside an area where the thin film 10 is disposed.

The second scale pattern 41 may help the user to match the position of incident light and the position of emitted light. In an embodiment, the second scale pattern 41 may indicate the position of incident light (i.e., the first light L1), and the first scale pattern 31 may indicate the position of emitted light (i.e., the second light L2 or the third light L3), for example. In this state, as the first scale pattern 31 and the second scale pattern 41 have a predetermined relationship (e.g., a ratio), the user may match the position of incident light and the position of emitted light based on the relationship.

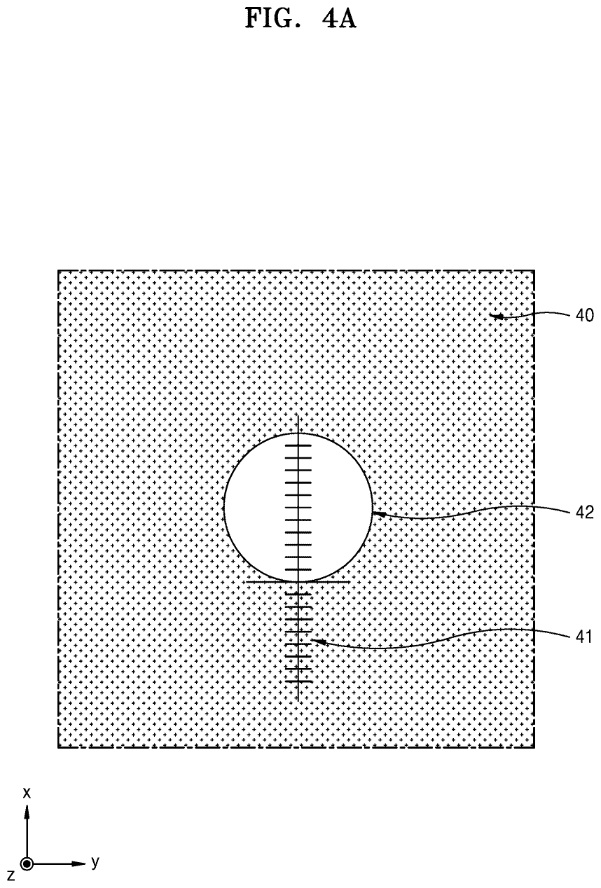

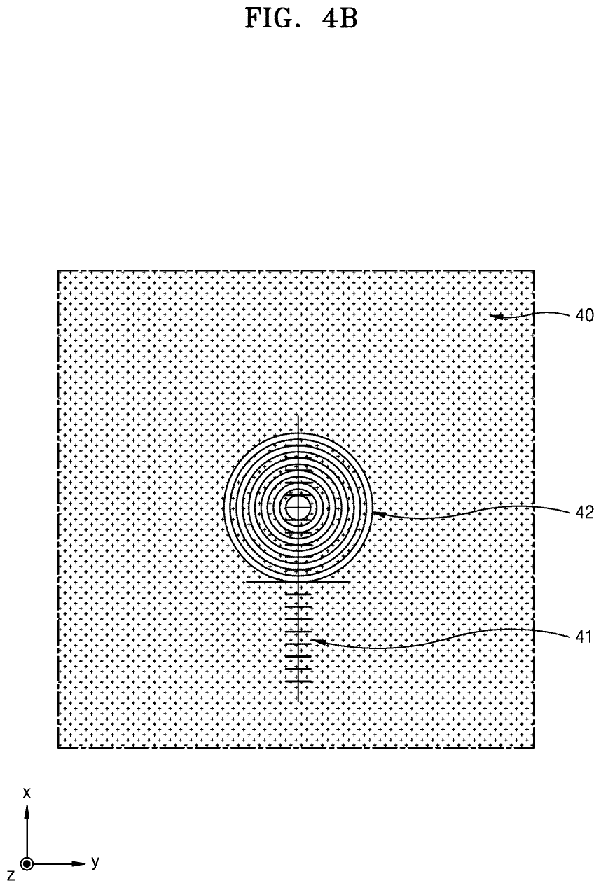

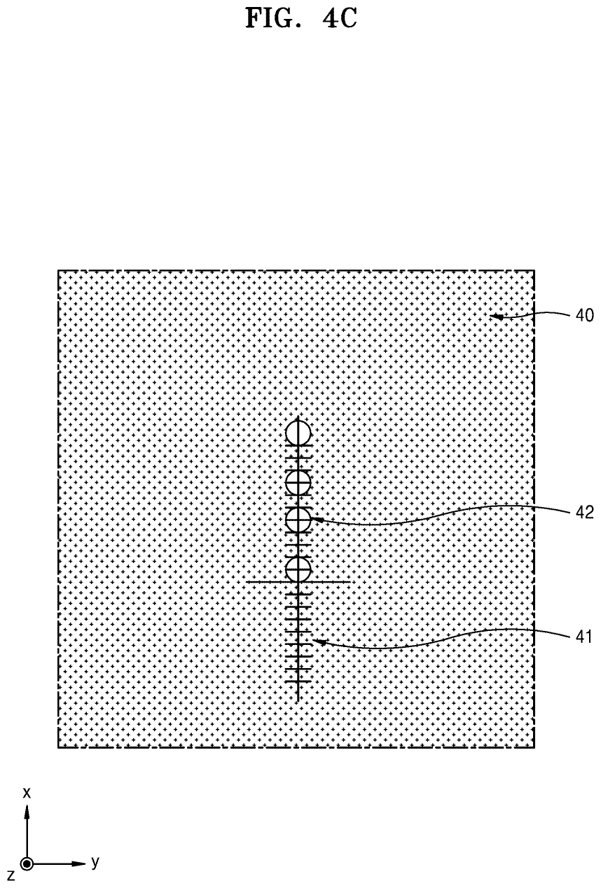

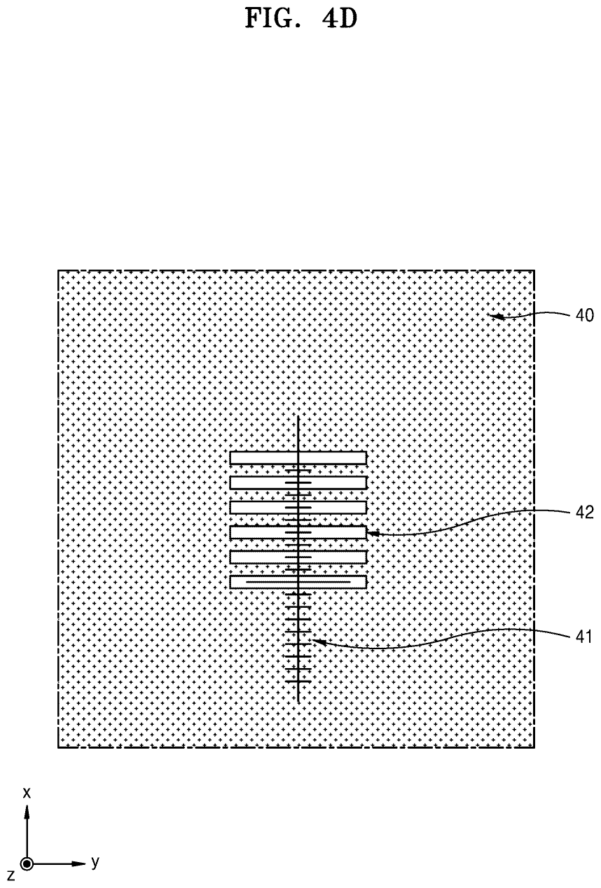

In an embodiment, the substrate 40 may include a transmission portion 42 through which the first light L1 may pass. In an embodiment, the transmission portion 42 of the substrate 40 may include a light transmissive material. In an embodiment, the transmission portion 42 of the substrate 40 may be in the form of an opening. The embodiment illustrated in FIG. 3 illustrates a case in which the transmission portion 42 of the substrate 40 includes a light transmissive material, and thus, the path of the first light L1 is bent on the surface of the substrate 40. In FIGS. 4A to 4D to refer to below, a case in which the transmission portion 42 is in the form of an opening is mainly illustrated. In an embodiment, the transmission portion 42 may overlap the thin film 10. In other words, the thin film 10 may be disposed on the substrate 40 to overlap the transmission portion 42.

FIGS. 4A, 4B, 4C, and 4D are schematic plan views showing embodiments of portions of the substrates 40 in some embodiments.

FIGS. 4A to 4D illustrate excerpts of a portion of the substrate 40 overlapping the thin film 10 described above. Referring to FIGS. 4A to 4D, the substrate 40 may include various forms of the second scale pattern 41 and/or the transmission portion 42. Although FIGS. 4A to 4D illustrate the transmission portion 42 in the form of an opening, the disclosure is not limited thereto, and the transmission portion 42 may include a light transmissive material. In other words, in an embodiment, a material disposed in the transmission portion 42 may be different from a material included in the substrate 40 outside the transmission portion 42.

Referring to FIG. 4A, the transmission portion 42 may have an approximately circular shape. In an embodiment, one portion of the second scale pattern 41 may overlap the transmission portion 42, and a remaining (the other) portion thereof may be disposed outside the transmission portion 42.

Referring to FIG. 4B, the transmission portion 42 may include concentric closed loops having different sizes from each other. In an embodiment, one portion of the second scale pattern 41 may overlap the closed loops of the transmission portion 42, and a remaining (the other) portion thereof may be disposed outside the transmission portion 42. In an embodiment, the marks of the second scale pattern 41 may overlap boundaries (or edges) of the closed loops. Although FIG. 4B illustrates an embodiment in which the closed loops are circular, the disclosure is not limited thereto, and the shape of closed loops may be modified in various ways. Furthermore, although FIG. 4B illustrates a total of five closed loops, the disclosure is not limited thereto, and the number of closed loops may also be modified in various ways.

Referring to FIG. 4C, the transmission portion 42 may include a plurality of circles arranged in a direction. In an embodiment, one portion of the second scale pattern 41 may overlap the circles of the transmission portion 42, and a remaining (the other) portion thereof may be disposed outside the transmission portion 42. In an embodiment, the circles of the transmission portion 42 may be arranged in a direction in which the second scale pattern 41 extends. In an embodiment, the marks of the second scale pattern 41 may overlap boundaries (or edges) of the circles of the transmission portion 42. Although FIG. 4C illustrates an embodiment in which the diameter of one circle matches two marks of the scale of the second scale pattern 41, the disclosure is not limited thereto, and the size of each circle of the transmission portion 42 may be modified in various ways. Although FIG. 4C illustrates a total of four circles, the disclosure is not limited thereto, and the number of circles may also be modified in various ways. In an embodiment, when the sizes and number of circles are appropriately adjusted, the embodiment illustrated in FIG. 4A may be implemented, for example.

Referring to FIG. 4D, a plurality of slits that extend in a direction and a plurality of slits arranged in another direction may be defined in the transmission portion 42. In an embodiment, the direction in which the slits extend may be perpendicular to the direction in which the slits are arranged. In an embodiment, one portion of the second scale pattern 41 may overlap the slits of the transmission portion 42, and a remaining (the other) portion thereof may be disposed outside the transmission portion 42. In an embodiment, the direction in which the slits extend may be the same as the direction in which the marks of the second scale pattern 41 extend. In an embodiment, the direction in which the slits are arranged may be the same as the direction in which the marks of the second scale pattern 41 are arranged. Although FIG. 4D illustrates an embodiment in which the slits of the transmission portion 42 are approximately quadrangular, e.g., rectangular, the disclosure is not limited thereto, and the shape of the slits may be modified in various ways. Although FIG. 4D illustrates a total of six slits, the disclosure is not limited thereto, and the number of slits may also be modified in various ways. Furthermore, in another embodiment, the shapes and/or sizes of slits may be different from each other.

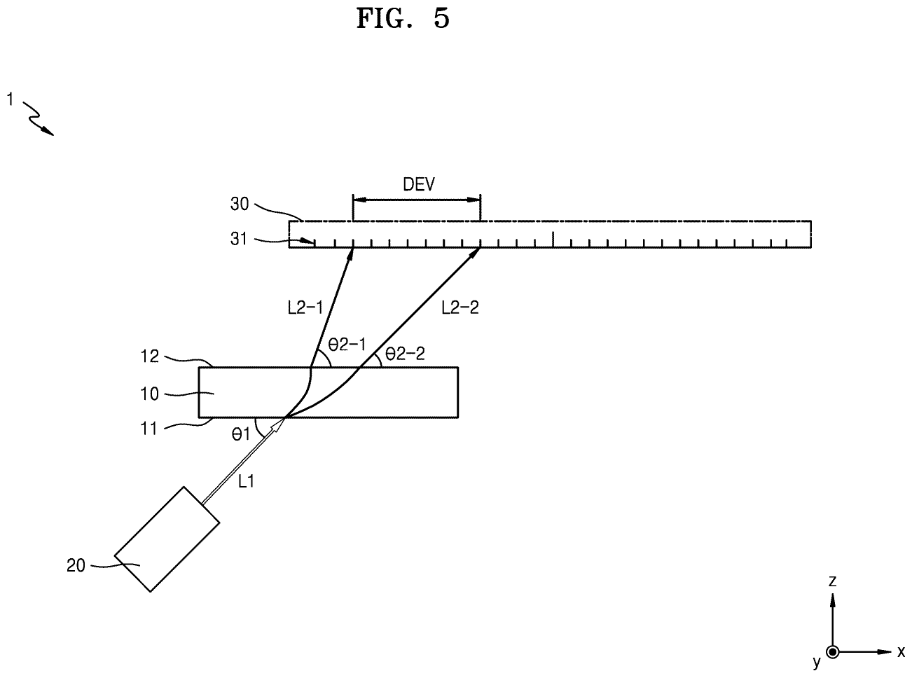

FIG. 5 is a schematic cross-sectional view of an embodiment of the thin film inspection device 1.

Referring to FIG. 5, the first light L1 may be light including various wavelength bands, e.g., white light. As the first light L1 that is white light passes through the thin film 10, aberration may occur. In an embodiment, as the first light L1 passes through the thin film 10, chromatic aberration may occur, for example.

In an embodiment, due to chromatic aberration, paths of light of different colors, that is, light of different wavelengths, may be different from each other. In an embodiment, after passing through the thin film 10, the first light L1 may be split into second-1 light L2-1 and second-2 light L2-2, for example. The second-1 light L2-1 and the second-2 light L2-2 may have different wavelengths, and thus, the colors thereof may be different from each other. The paths of the second-1 light L2-1 and the second-2 light L2-2 may be different from each other. The emission angle of the second-1 light L2-1 may be defined as a second-1 angle θ2-1, and the emission angle of the second-2 light L2-2 may be defined as a the second-2 angle θ2-2. In other words, an angle defined by the second-1 light L2-1 with the second surface 12 of the thin film 10 may be defined as the second-1 angle θ2-1, and an angle defined by the second-2 light L2-2 with the second surface 12 of the thin film 10 may be defined by the second-2 angle θ2-2. In an embodiment, the second-1 angle θ2-1 and the second-2 angle θ2-2 may be different from the first angle θ1. In an embodiment, the second-1 angle θ2-1 and the second-2 angle θ2-2 may be different from each other. In an embodiment, the second-1 angle θ2-1 and the second-2 angle θ2-2 may vary depending on the first angle θ1 and the characteristics of the thin film 10.

The second-1 light L2-1 and the second-2 light L2-2 illustrated in FIG. 5 are only two embodiments of the lights split due to occurrence of aberration. Although lights of various wavelength may additionally exist between the second-1 light L2-1 and the second-2 light L2-2, the lights of various wavelength are omitted for convenience of explanation and illustration. In an embodiment, the second-1 light L2-1 may be red light, the second-2 light L2-2 may be purple light, and a spectrum of lights of other colors may exist between the second-1 light L2-1 and the second-2 light L2-2. In another embodiment, the second-1 light L2-1 may be purple light, and the second-2 light L2-2 may be red light.

The path of the second-1 light L2-1 and the path of the second-2 light L2-2 are different from each other, and thus, the position where the second-1 light L2-1 is detected on the light-receiving portion 30 and the position where the second-2 light L2-2 is detected on the light-receiving portion 30 may be different from each other. A deviation DEV may exist between the position where the second-1 light L2-1 is detected and the position where the second-2 light L2-2 is detected. The deviation DEV may vary depending on the characteristics of the thin film 10. Accordingly, the user may allow the first light L1 that is white light to pass through the thin film 10 and measure the deviation DEV between emitted lights (e.g., the second-1 light L2-1 and the second-2 light L2-2) in which chromatic aberration occurs, thereby predicting the characteristics of the thin film 10.

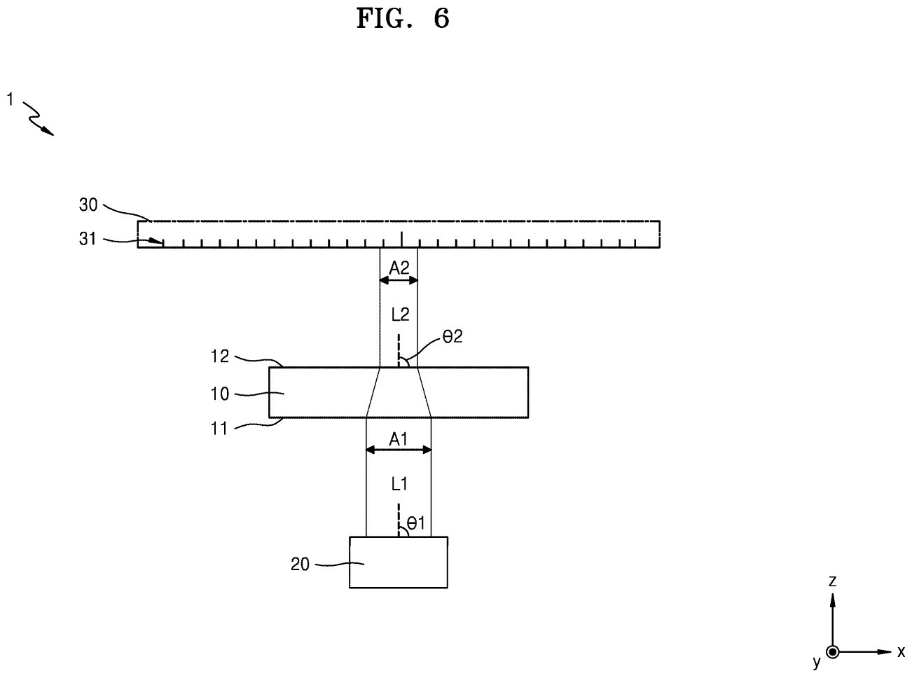

FIG. 6 is a schematic cross-sectional view of an embodiment of the thin film inspection device 1.

Referring to FIG. 6, the light source 20 may be a surface light source, and the first light L1 may be surface light.

In an embodiment, the first light L1 that is incident light may travel in the third direction z. In an embodiment, the first light L1 may be incident on the first surface 11 of the thin film 10 in a direction perpendicular thereto. In an embodiment, the first angle θ1 may be 90°. In an embodiment, the first light L1 may have a first area A1.

In an embodiment, the second light L2 that is emitted light may travel in the third direction z. In an embodiment, the second light L2 may be emitted vertically from the second surface 12 of the thin film 10. In an embodiment, the second angle θ2 may be 90°. In an embodiment, the second light L2 may have a second arca A2.

In an embodiment, the first area A1 and the second area A2 may be different from each other. As the refraction of the first light L1 occurs multiple times within the thin film 10, the area of the first light L1 may vary while the first light L1 passes through the thin film 10. In an embodiment, the second area A2 may be smaller than the first area A1. However, this is an illustrative embodiment, and in another embodiment, the second area A2 may be greater than the first area A1. In an embodiment, the first area A1 may be adjusted by the user. In an embodiment, a ratio of the second area A2 to the first area A1 may vary depending on the characteristics of the thin film 10. In other words, as the first area A1 may be adjusted by the user, the second area A2 may vary depending on the characteristics of the thin film 10. Accordingly, the user sets the first area A1, as desired, and measures the second area A2, thereby predicting the characteristics of the thin film 10.

In the description of the thin film inspection device 1 above with reference to FIGS. 2, 3, 5, and 6, the principle of operation of the thin film inspection device 1 according to the configuration thereof is described. Accordingly, a person skilled in the art to which the disclosure pertains would understand that the descriptions presented above are related to not only the thin film inspection device but also the thin film inspection method.

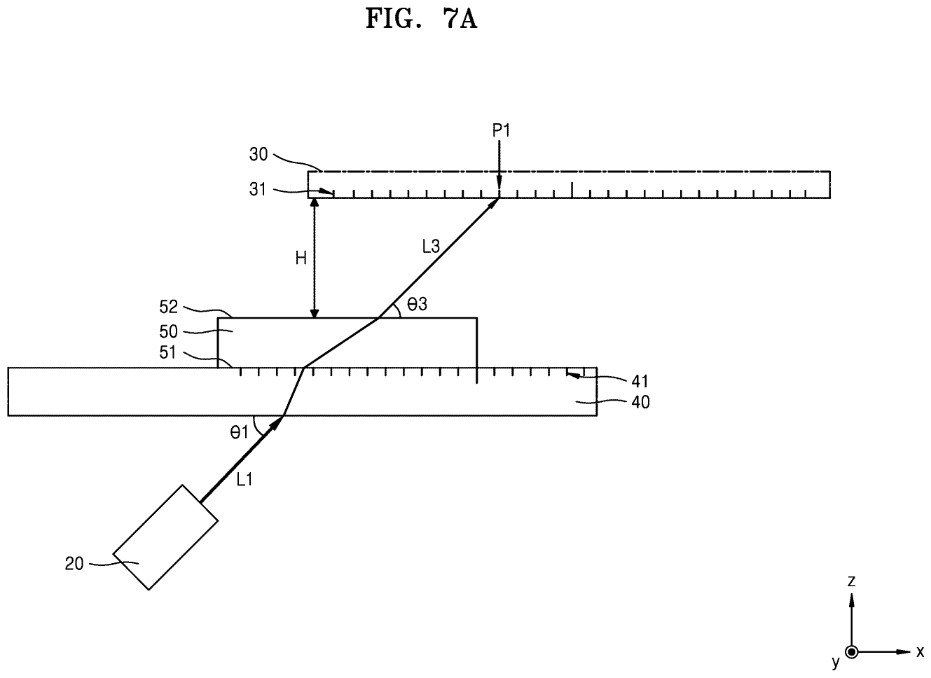

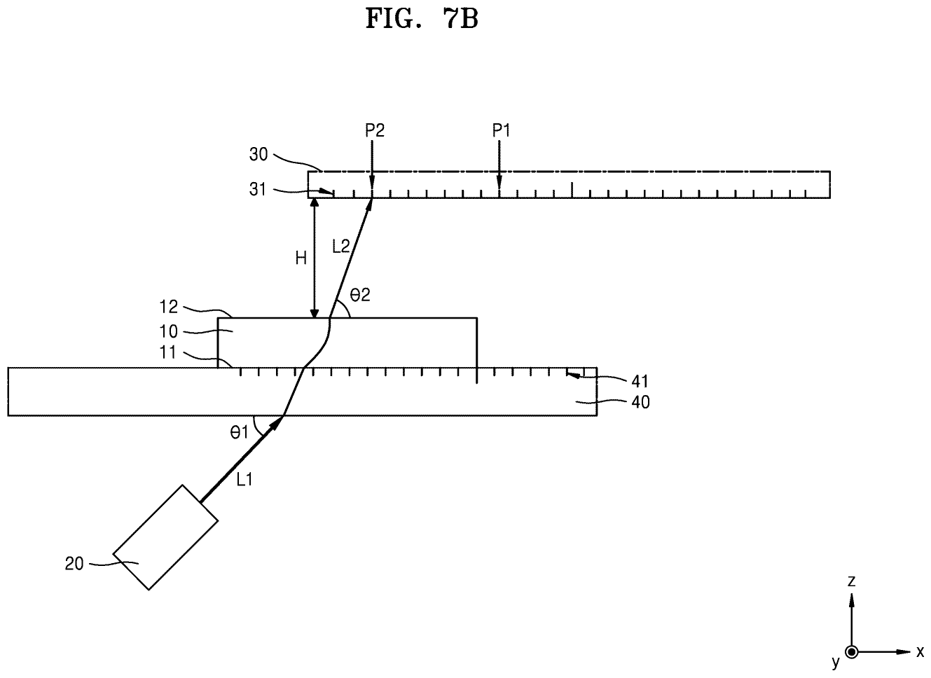

FIGS. 7A and 7B are schematic cross-sectional views showing an embodiment of operations of a thin film inspection method.

Referring to FIGS. 7A and 7B, the substrate 40 may be disposed between the light source 20 and the light-receiving portion 30. In the illustrated embodiment, the light source 20 may be a point light source, and the first light L1 may be point light of a single wavelength. In the illustrated embodiment, the light-receiving portion 30 may include the first scale pattern 31, and the substrate 40 may include the second scale pattern 41.

Referring to FIG. 7A, a comparison thin film 50 may be disposed on the substrate 40. The comparison thin film 50, unlike the thin film 10 (FIG. 7B) described below, may be a kind of a specimen for reference, for comparison, not an object to be subject to inspection. The comparison thin film 50 may include a first surface 51 and a second surface 52. The first surface 51 of the comparison thin film 50 may face the substrate 40 and may contact the substrate 40. The second surface 52 of the comparison thin film 50 may face the light-receiving portion 30. The first surface 51 of the comparison thin film 50 may be a lower surface of the comparison thin film 50, and the second surface 52 of the comparison thin film 50 may be an upper surface of the comparison thin film 50. The second surface 52 of the comparison thin film 50 and the light-receiving portion 30 may be spaced apart from each other by a height H.

After the comparison thin film 50 is disposed on the substrate 40, the first light L1 may be emitted from the light source 20 toward the comparison thin film 50. In the illustrated embodiment, the comparison thin film 50 may have a constant refractive index. By emitting the first light L1 toward the comparison thin film 50 (or toward the substrate 40), the third light L3 described above with reference to FIGS. 2 and 3 may be implemented. In other words, the emitted light of the first light L1 with respect to the comparison thin film 50 may be the third light L3. In the illustrated embodiment, the first angle θ1 and the third angle θ3 may be the same as each other. A position where emitted light (i.e., the third light L3) having passed through a film with a constant refractive index is detected on the light-receiving portion 30 may be represented as a first position P1.

Referring to FIG. 7B, the comparison thin film 50 may be removed, and the thin film 10 may be disposed on the substrate 40. In this state, the second scale pattern 41 of the substrate 40 may be utilized to place the thin film 10 at the same position as the position where the comparison thin film 50 is disposed. In the illustrated embodiment, the thin film 10 may be subject to inspection. In this state, other conditions may remain unchanged, except that the comparison thin film 50 is replaced with the thin film 10. In an embodiment, conditions related to the first light L1, e.g., a condition of a separation height H, may be the same in FIGS. 7A and 7B, for example.

Then, the first light L1 may be emitted from the light source 20 toward the thin film 10. The refractive index of the thin film 10 may vary in the thickness direction (e.g., the third direction z), and the first light L1 may refract multiple times within the thin film 10. The emitted light of the first light L1 with respect to thin film 10 may be the second light L2. A position where emitted light (i.e., the second light L2) having passed through a film with a varying refractive index is detected on the light-receiving portion 30 may be represented as a second position P2.

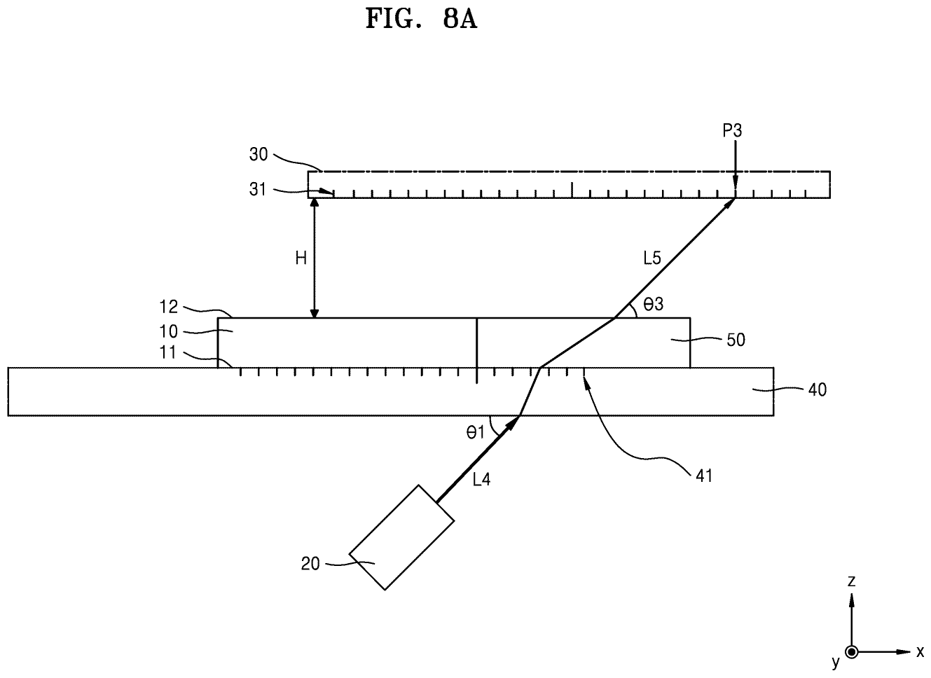

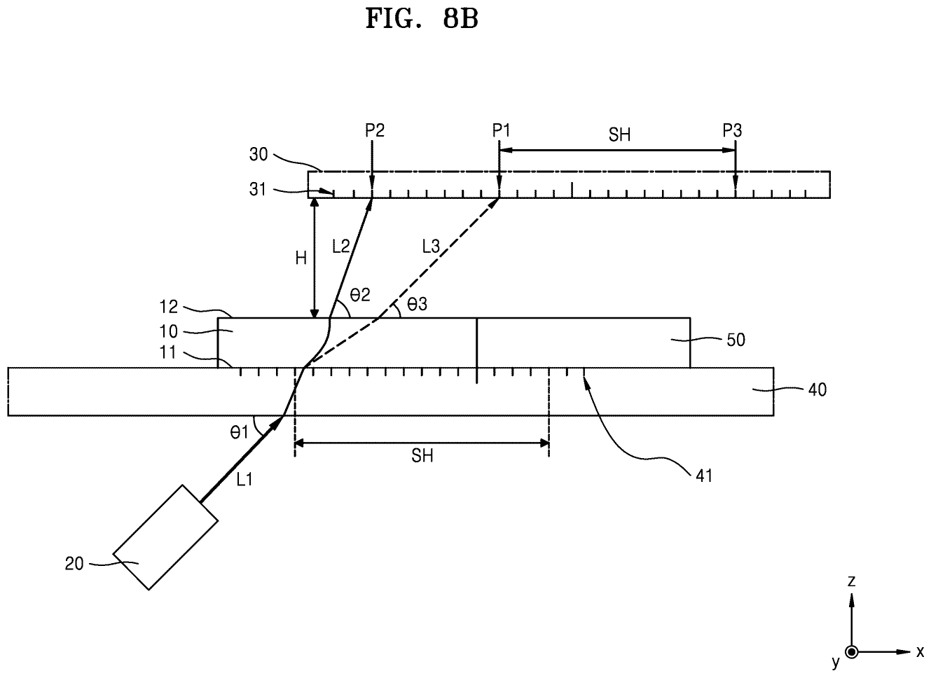

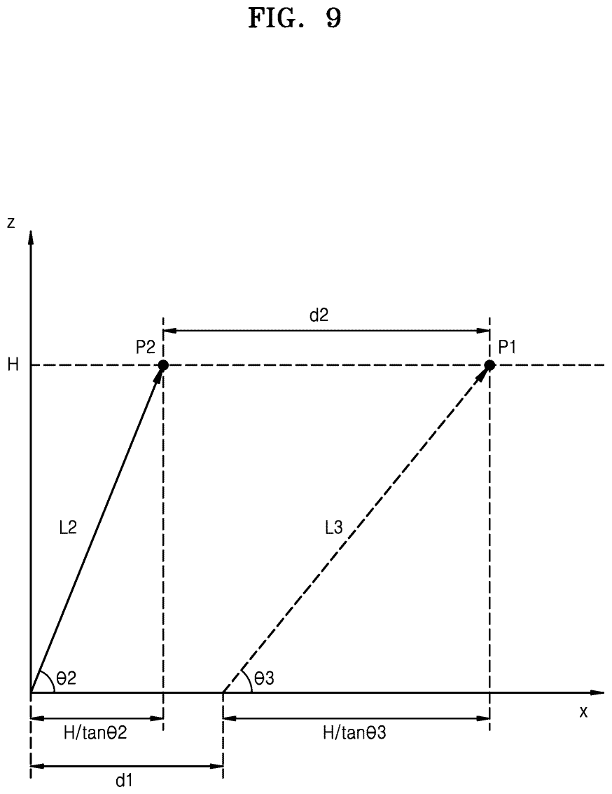

Then, by comparing the first position P1 with the second position P2, the characteristics (e.g., the second angle θ2) of the emitted light (e.g., the second light L2), furthermore, the characteristics of the thin film 10 may be predicted. Details of such prediction will be described below with reference to FIG. 9, and another embodiment of the method of deriving the first position P1 and the second position P2 is described with reference to FIGS. 8A and 8B.

FIGS. 8A and 8B are schematic cross-sectional views showing another embodiment of operations of a thin film inspection method.

Referring to FIGS. 8A and 8B, the thin film 10 and the comparison thin film 50 may be simultaneously disposed on the substrate 40. In an embodiment, the comparison thin film 50 may be disposed in the first direction x of the thin film 10, for example. In the illustrated embodiment, the thin film 10 and the comparison thin film 50 may contact each other or apart from each other. FIGS. 8A and 8B illustrate an embodiment in which the thin film 10 and the comparison thin film 50 contact each other. In the illustrated embodiment, an upper surface of each of the thin film 10 and the comparison thin film 50 and the light-receiving portion 30 may be spaced apart from each other by a height H. In the illustrated embodiment, the light source 20 may move in a direction (e.g., first direction x).

Referring to FIG. 8A, the light source 20 may emit fourth light L4 toward the comparison thin film 50 (or toward the substrate 40). The incident angle of the fourth light L4 may be the first angle θ1. Fifth light L5 that is emitted light of the fourth light L4 may define the third angle θ3 with an upper surface of the comparison thin film 50. In other words, the emission angle of the fifth light L5 may be the third angle θ3. In the illustrated embodiment, the first angle θ1 and the third angle θ3 may be the same as each other. As a whole, the relationship between the fourth light L4 and the fifth light L5 may be similar to the relationship between the first light L1 and the third light L3, as described above with reference to FIG. 7A. A position where the fifth light L5 is detected on the light-receiving portion 30 may be represented as a third position P3.

Referring to FIG. 8B, the light source 20 may be moved in the first direction x. In this state, an interval SH of the light source 20 may be measured on the second scale pattern 41. An interval SH corresponding to the interval SH measured on the second scale pattern 41 may be predicted in the first scale pattern 31. FIG. 8B illustrates a case in which the intervals SH are identically indicated on the first scale pattern 31 and the second scale pattern 41 because the first scale pattern 31 and the second scale pattern 41 are the same as each other. In another embodiment, an interval on the first scale pattern 31 and an interval on the second scale pattern 41 may differ as much as a ratio between the first scale pattern 31 and the second scale pattern 41. When the detected position of the fifth light L5 is shifted as much as the movement interval of the light source 20, that is, the interval SH of shifting the incidence position of the fourth light L4, a position detected when the first light L1 passes through the comparison thin film 50 may be predicted. In other words, when the third position P3 is shifted as much as the interval SH, the first position P1 may be predicted. This is possible because the first scale pattern 31 and the second scale pattern 41 according to the disclosure correspond to each other. When the method in the illustrated embodiment method is used, it may be possible to predict the first position P1 without having to replace a film disposed on the substrate 40.

Then, similarly to the description presented with reference to FIG. 7B, by making the first light L1 incident on a thin film, the second light L2 and the second position P2 may be derived. Then, by comparing the first position P1 with the second position P2, the characteristics (e.g., the second angle θ2) of the emitted light (e.g., the second light L2), furthermore the characteristics of the thin film 10, may be predicted.

The embodiments illustrated in FIGS. 7A and 7B and the embodiments illustrated in FIGS. 8A and 8B methods of deriving the first position P1 and the second position P2. A method of predicting the characteristics of the thin film 10 using the first position P1 and the second position P2 that are derived using FIGS. 7A and 7B, or FIGS. 8A and 8B, is described with reference to FIG. 9.

FIG. 9 is a schematic graph showing an embodiment of an operation of a thin film inspection method in an embodiment represented in an orthogonal coordinate system.

Referring to FIG. 9, for consistency with the drawings presented above, the horizontal axis and the vertical axis are represented as an x axis which may correspond to the first direction x and a z axis which may correspond to the third direction z, respectively. Paths of the second light L2 and the third light L3, which are emitted light, are shown in the form of vectors. The origin of a vector of the second light L2 may be a position where the second light L2 emitted from the thin film 10. The end portion of the vector of the second light L2 may be a position where the second light L2 is detected on the light-receiving portion 30, that is, the second position P2. The origin of a vector of the third light L3 may be a position where the third light L3 is emitted from the thin film 10 (or the comparison thin film 50). The end point of the vector of the third light L3 may be a position where the third light L3 is detected on the light-receiving portion 30, that is, the first position P1. Referring to the graph, points where z=0 may be on an upper surface of the thin film 10 (or the comparison thin film 50). Furthermore, points where z=H may be on a lower surface of the light-receiving portion 30 or points where each light is detected. In other words, as described above, the upper surface of the thin film 10 (or the comparison thin film 50) may be spaced apart from the light-receiving portion 30 by a height H. The second angle θ2 and the third angle θ3 are angles respectively defined by the second light L2 and the third light L3 with the upper surfaces (i.e., z=0) of the thin film 10 (or the comparison thin film 50).

The origin of the second light L2 and the origin of the third light L3 may be spaced apart from each other by a first distance d1. In an embodiment, the first distance d1 may be measured using the second scale pattern 41. The end point (i.e., the second position P2) of the second light L2 and the end point (i.e., the first position P1) of the third light L3 may be spaced apart from each other by a second distance d2. In an embodiment, the second distance d2 may be measured using the first scale pattern 31.

In the illustrated embodiment, the characteristics of the comparison thin film 50 may be user adjustable. In other words, the third angle θ3 is a user adjustable variable. Furthermore, the height H is also a user adjustable variable. The purpose of the illustrated embodiment lies in identifying the characteristics of the thin film 10 through the identification of the characteristics of the second light L2. In other words, the variable to be derived in the illustrated embodiment may be the second angle θ2. Accordingly, when the third angle θ3 and the height H are known and the first distance d1 and the second distance d2 are obtained through measurements, the second angle θ2 may be derived through following Equation 1.

$$d 2 - d 1 = \frac{H}{tan θ 3} - \frac{H}{tan θ 2} \qquad [ Equation 1 ]$$

$$tan θ 2 = \frac{1}{\frac{1}{tan θ 3} + \frac{d 1 - d 2}{H}}$$

$$θ 2 = {tan}^{- 1} ( \frac{1}{\frac{1}{tan θ 3} + \frac{d 1 - d 2}{H}} )$$

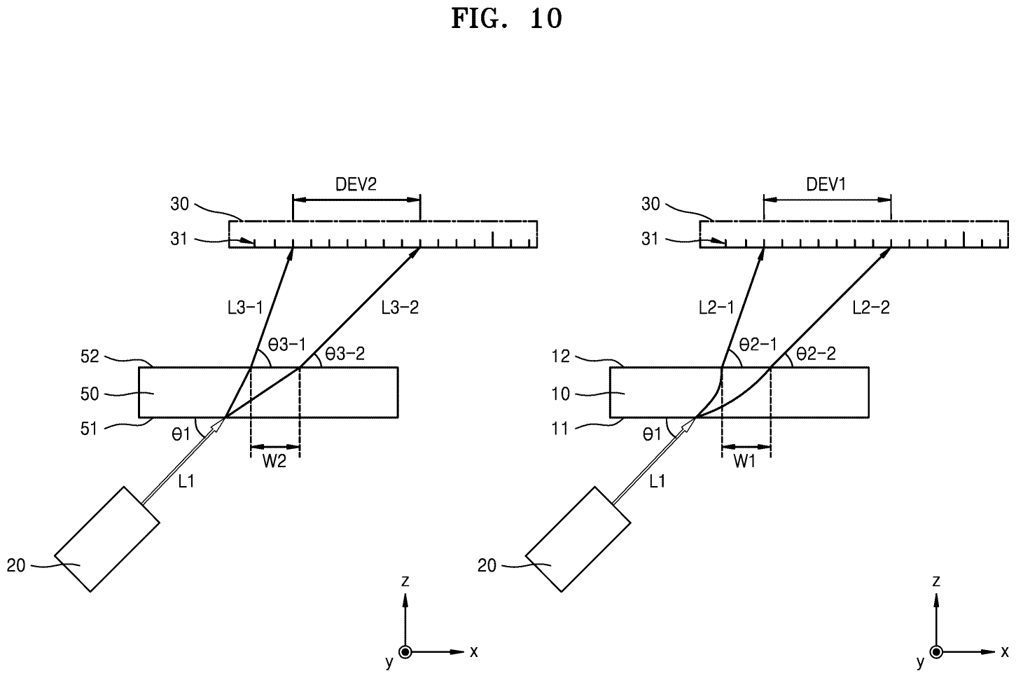

FIG. 10 is a schematic cross-sectional view showing an embodiment of an operation of a thin film inspection method.

Referring to FIG. 10, similarly to the embodiment illustrated in FIG. 5, the first light L1 may be white light including light of various wavelength bands, for example. An embodiment in which the first light L1 is incident on the thin film 10 is illustrated on the right, and an embodiment in which the first light L1 is incident on the comparison thin film 50 is illustrated on the left. The embodiment in which the first light L1 is incident on the thin film 10 and thus chromatic aberration occurs is similar to the description presented with reference to FIG. 5. When the first light L1 is incident on the comparison thin film 50, the first light L1 is split into third-1 light L3-1 and third-2 light L3-2, and chromatic aberration may occur, which may be partially similar to the case in which the first light L1 is incident on the thin film 10.

When the first light L1 is incident on the thin film 10, emitted light may be the second-1 light L2-1 and the second-2 light L2-2. The second-1 light L2-1 may define the second-1 angle θ2-1 with the second surface 12 of the thin film 10. The second-2 light L2-2 may define the second-2 angle θ2-2 with the second surface 12 of the thin film 10. A distance between the origin of the second-1 light L2-1 and the origin of the second-2 light L2-2 may be defined as a first width W1. A distance between the end portion of the second-1 light L2-1 and the end point of the second-2 light L2-2 may be defined as a first deviation DEV1. In other words, a detected position of the second-1 light L2-1 and a detected position of the second-2 light L2-2 may be defined as the first deviation DEV1.

When the first light L1 is incident on the comparison thin film 50, emitted light may be the third-1 light L3-1 and the third-2 light L3-2. The third-1 light L3-1 may define a third-1 angle θ3-1 with the second surface 52 of the comparison thin film 50. The third-2 light L3-2 may define a third-2 angle θ3-2 with the second surface 52 of the comparison thin film 50. A distance between the origin of the third-1 light L3-1 and the origin of the third-2 light L3-2 may be defined as a second width W2. A distance between the end point of the third-1 light L3-1 and the end point of the third-2 light L3-2 may be defined as a second deviation DEV2. In other words, a distance between a detected position of the third-1 light L3-1 and a detected position of the third-2 light L3-2 may be defined as the second deviation DEV2.

The comparison thin film 50 may be selected by the user (because it is a specimen for reference). Accordingly, the third-1 angle θ3-1, the third-2 angle θ3-2, the second width W2, and the second deviation DEV2 may be values known to the user. The user may compare the second-1 angle θ2-1 with the third-1 angle θ3-1. The user may compare the second-2 angle θ2-2 with the third-2 angle θ3-2. The user may compare the first width W1 with the second width W2. The user may compare the first deviation DEV1 with the second deviation DEV2. The user may predict the characteristics of the thin film 10 through the comparison of the above various variables.

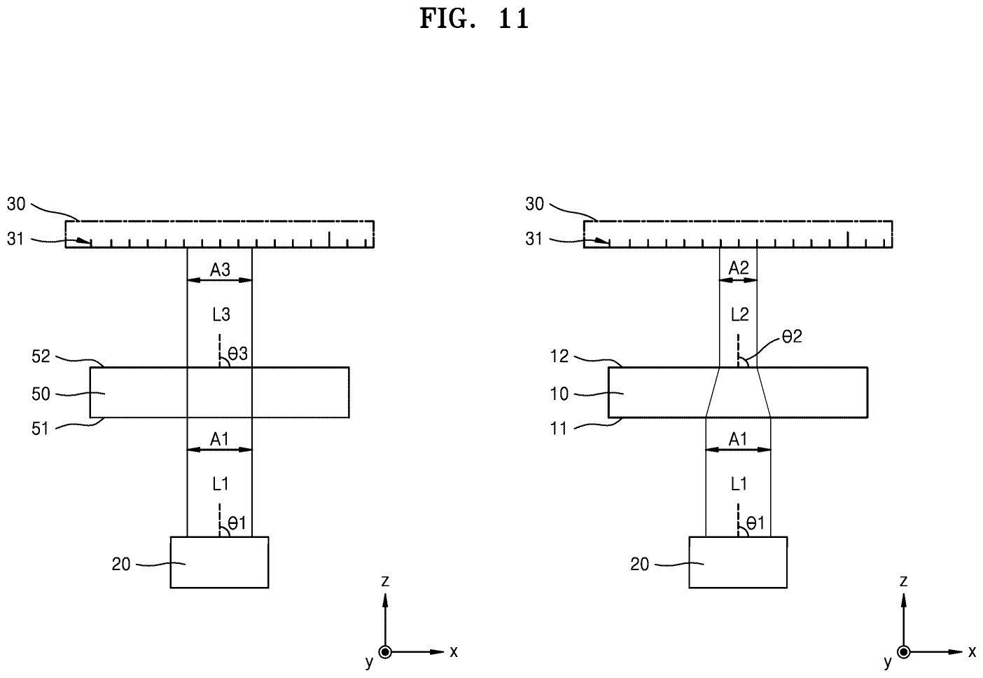

FIG. 11 is a schematic cross-sectional view showing an embodiment of an operation of a thin film inspection method.

Referring to FIG. 11, similarly to the embodiment illustrated in FIG. 6, the light source 20 may be a surface light source, and the first light L1 may be surface light. An embodiment in which the first light L1 is incident on the thin film 10 is illustrated on the right, and an embodiment in which the first light L1 is incident on the comparison thin film 50 is illustrated on the left. The embodiment in which the first light L1 is incident on the thin film 10 is similar to the description presented with reference to FIG. 6. The case in which the first light L1 is incident on the comparison thin film 50 may also be partially similar to the case in which the first light L1 is incident on the thin film 10.

When the first light L1 is incident on the thin film 10, emitted light may be the second light L2. The first light L1 may have the first area A1. The second light L2 may have the second area A2. In an embodiment, the first area A1 and the second area A2 may be different from each other. In an embodiment, as illustrated in FIG. 11, the second area A2 may be smaller than the first area A1. In another embodiment, different from the illustration in FIG. 11, the second area A2 may be larger than the first area A1. In an embodiment, the first angle θ1 that is an incident angle of the first light L1 and the second angle θ2 that is an emission angle of the second light L2 may be the same as each other. In an embodiment, the first angle θ1 may be about 90°. In an embodiment, the second angle θ2 may be about 90°.

When the first light L1 is incident on the comparison thin film 50, emitted light may be the third light L3. The first light L1 may have the first area A1. The third light L3 may have a third area A3. In an embodiment, as illustrated in FIG. 11, the first area A1 and the third area A3 may be the same as each other. In another embodiment, different from the illustration in FIG. 11, the first area A1 and the third area A3 may be different from each other. In an embodiment, the first angle θ1 that is an incident angle of the first light L1 and the third angle θ3 that is an emission angle of the third light L3 may be same as each other. In an embodiment, the first angle θ1 may be about 90°. In an embodiment, the third angle θ3 may be about 90°.

The comparison thin film 50 may be selected by the user (because it is a specimen for reference). Accordingly, the first area A1, the first angle θ1, the third area A3, and the third angle θ3 may be values known to the user. In an alternative embodiment, the third angle θ3 may be obtained through a measurement. The user may predict the characteristics of the thin film 10 by comparing the first area A1 with the second area A2. Furthermore, the user may predict the characteristics of the thin film 10 by comparing the second area A2 with the third area A3.

By the embodiments described above, as a device and method for inspecting a thin film with a varying refractive index, provided are an inspection device and method for predicting the characteristics of a thin film by emitting light that transmits a thin film, measuring a position where emitted light (i.e., transmitted light) is detected, and comparing the position where the emitted light is detected with a position where emitted light (i.e., transmitted light) is detected when a refractive index is constant. The disclosure is not limited to such an effect.

It should be understood that embodiments described herein should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. A device for inspecting a thin film with a varying refractive index, the device comprising:
a light source which emits first light toward a first surface of the thin film, the first light being incident at a first angle with reference to the first surface on the first surface; and
a light-receiving portion which detects second light emitted from a second surface of the thin film, the second light being emitted at a second angle with reference to the second surface,
wherein the first surface is one of an upper surface and a lower surface of the thin film, and
the second surface is a remaining one of the upper surface and the lower surface of the thin film.

2. The device of claim 1, wherein the light source and the light-receiving portion are arranged on opposite sides with respect to the thin film.

3. The device of claim 1, wherein the thin film has a refractive index which gradually varies in a predetermined direction, and
the first angle and the second angle are different from each other.

4. The device of claim 1, wherein the light-receiving portion includes a first scale pattern indicating a position where the second light is detected.

5. The device of claim 4, further comprising:
a substrate including a second scale pattern corresponding to the first scale pattern,
wherein the thin film is disposed on the substrate.

6. The device of claim 5, wherein the second scale pattern is partially overlapped with the thin film and extending outside an area where the thin film is disposed.

7. The device of claim 5, wherein the substrate comprises a transmission portion, and the thin film is at least partially overlapped with the transmission portion.

8. The device of claim 1, wherein the first light comprises white light.

9. The device of claim 1, wherein the light source comprises a surface light source, and an area of the first light and an area of the second light are different from each other.

10. A method of inspecting a thin film with a varying refractive index, the method comprising:
emitting, by a light source, first light toward a first surface of the thin film, the first light being incident at a first angle with reference to the first surface on the first surface; and
detecting, by a light-receiving portion, second light emitted from a second surface of the thin film, the second light being emitted at a second angle with reference to the second surface;
wherein the first surface is one of an upper surface and a lower surface of the thin film, and
the second surface is a remaining one of the upper surface and the lower surface of the thin film.

11. The method of claim 10, wherein the light source and the light-receiving portion are arranged on opposite sides with respect to the thin film.

12. The method of claim 10, wherein the first angle and the second angle are different from each other.

13. The method of claim 10, wherein the light-receiving portion includes a first scale pattern indicating a position where the second light is detected,
the method further comprising deriving a position where the second light is detected.

14. The method of claim 13, further comprising deriving a position where third light which is emitted light of the first light is detected when a refractive index of the thin film is constant.

15. The method of claim 14, further comprising determining the second angle by comparing a detected position of the second light and a detected position of the third light.

16. The method of claim 13, further comprising arranging the thin film on a substrate including a second scale pattern corresponding to the first scale pattern.

17. The method of claim 16, wherein the substrate comprises a transmission portion, and the thin film is at least partially overlapped with the transmission portion.

18. The method of claim 16, wherein the second scale pattern is partially overlapped with the thin film and extending outside an area where the thin film is disposed.

19. The method of claim 10, wherein the first light comprises white light, and chromatic aberration occurs in the second light which has passed through the thin film so that a detected position varies for each wavelength of the second light, the method further comprising measuring a deviation between different detected positions for each wavelength of the second light.

20. The method of claim 10, wherein the light source comprises a surface light source, and an area of the first light and an area of the second light are different from each other, the method further comprising comparing the area of the first light and the area of the second light.
